(19) United States
(12) Patent Application Publication
(10) Pub. No.: US 2005/0154775 A1
(43) Pub. Date: Jul. 14, 2005

(54) Contacting a recipient by a preferred technique via a page

(75) Inventors: John Ernest McGinn, Rochester, MN (US); Thomas Edwin Murphy JR., Rochester, MN (US); Paul F. Rieth, Rochester, MN (US); Jeffrey Scott Stevens, Rochester, MN (US)

Correspondence Address: Grant A. Johnson;IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 10/753,522

(22) Filed: Jan. 8, 2004

(51) Int. Cl. G06F 15/16

(52) U.S. Cl. 709/200

(57) ABSTRACT

A method, apparatus, system, and signal-bearing medium that in an embodiment determine a server and a preferred delivery technique for a recipient based on information encoded in a page. In various embodiments, an identification of the server may be encoded in the page. The recipient is selected via the page, and a message is sent to the recipient via the server and the preferred delivery technique.

### FIELD

This invention generally relates to computers and more specifically relates to contacting a recipient by a preferred technique via a page.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs.

Computers were previously standalone devices that did not communicate with one another. But, increasingly computers are connected via networks. One common network is called the Internet, and many businesses have web sites on the Internet where they provide information about themselves, communicate with customers and potential customers, and sell goods and services, for example via online ordering systems. This technique for conducting business (as opposed to a traditional store front or office building) is often called electronic commerce.

But, many businesses, especially small or very small businesses, do not participate in electronic commerce and do not have an Internet web presence or even a personal computer and may not be planning to ever own one. Other businesses have a simple web page but do not have online ordering for their products or services, so they require their customers to write a letter or print out an order form from the web page, fill out the form manually via a pen or typewriter, and then fax or mail the form or letter. Also, many potential customers do not have a dedicated Internet connection, so even making a phone call or fax requires the customer to drop the Internet connection to use the telephone. Since electronic commerce is a convenient way for customers to find businesses and order their products and services, businesses that do not participate fully run the risk of losing customers.

Such businesses may not have the money to spend on technology, may have security concerns, may lack the technical skill, or may simply be comfortable with using their telephone, fax machine, and/or storefront, and are reluctant to change from a business model that is known and comfortable, to a business model that is new and unfamiliar. Thus, the fact that these businesses are not participating fully in electronic commerce may not be based on a conscious evaluation of the costs versus the benefits. Since consumers are increasingly turning to electronic commerce to find and order goods and services, businesses that are not fully participating are increasingly suffering from a loss of revenue. If electronic commerce were less expensive, more convenient, and more similar to existing business models, these businesses might participate and enjoy the benefits.

The added expense of electronic commerce exacerbates a problem that many businesses already have, which is that finding potential customers through advertising, soliciting potential customers, and receiving customer requests, messages, and orders takes a large percentage of the effort, time, and budget available to the business. Other business activities, such as outgoing messages and billing are relatively small in comparison. Thus, businesses are often reluctant to add the additional expense of electronic commerce to an already large budget.

Without a more convenient way for businesses to conduct electronic commerce, they will continue to suffer from a loss of revenue and customers will continue to suffer from inconvenience.

### SUMMARY

A method, apparatus, system, and signal-bearing medium are provided that in an embodiment determine a server and a preferred delivery technique for a recipient based on information encoded in a page. In various embodiments, an identification of the server may be encoded in the page. The recipient is selected via the page, and a message is sent to the recipient via the server and the preferred delivery technique.

### BRIEF DESCRIPTION OF THE DRAWINGS

FIG. 1 depicts a block diagram of an example system for implementing an embodiment of the invention.

FIG. 2A depicts a pictorial representation of an example user interface, according to an embodiment of the invention.

FIG. 2B depicts a pictorial representation of an example dialog, according to an embodiment of the invention.

FIG. 3 depicts a block diagram of an example data structure, according to an embodiment of the invention.

FIG. 4 depicts a flowchart of example processing, according to an embodiment of the invention.

FIG. 5 depicts a flowchart of example processing for contacting a recipient via a preferred technique, according to an embodiment of the invention.

### DETAILED DESCRIPTION

In an embodiment, information about a recipient is encoded into a web page. The information may include a preferred technique for contacting the recipient and an identification of a server. An applet associated with the web page sends a message to the recipient via the server and the preferred technique. The server may be located within the area code or area code and exchange of the recipient, in order to reduce or eliminate the cost of contacting the recipient.

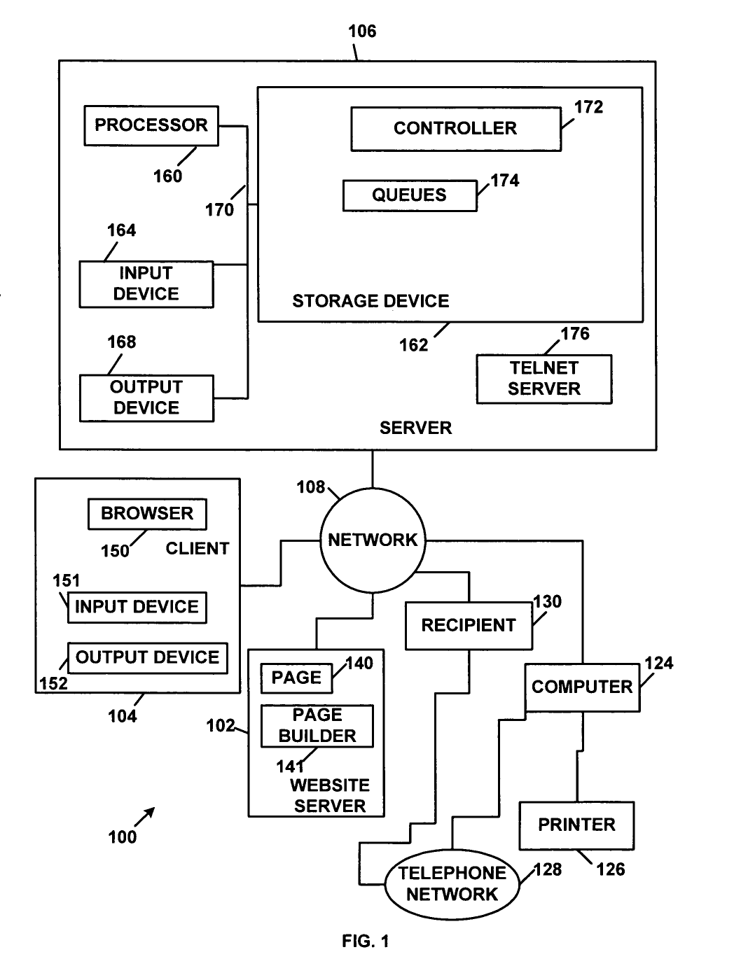

Referring to the Drawing, wherein like numbers denote like parts throughout the several views, FIG. 1 depicts a block diagram of an example system 100 for implementing an embodiment of the invention. The system 100 includes a website server 102, a client 104, a server 106, a computer 124, and a recipient 130, all connected via a network 108. The computer 124 is further connected to a printer 126 and a telephone network 128. The telephone network 128 is further connected to the recipient 130. In other embodiments, the computer 124 may be directly connected to the server 106 or may be a part of the server 106. In another embodiment, the computer 124 may be connected to the printer 126 via a network, such as the network 108. In other embodiments, the printer 126 may be connected directly to the server 106 or may be a part of the server 106.

Although the elements illustrated in FIG. 1 are drawn as being discrete, separate components, in other embodiments some or all of their functions and elements may be combined, and in yet other embodiments some may be optional or not present. Further, any number of each element in FIG. 1 may be present and each may exist at multiple levels.

The website server 102 includes a page 140 and a page builder 141. The page builder 141 encodes information about the recipient 130, possibly including a preferred contact technique, into the page 140. The page 140 may include an applet or be associated with an applet. In various embodiments, the applet may include executable or interpretable code or statements.

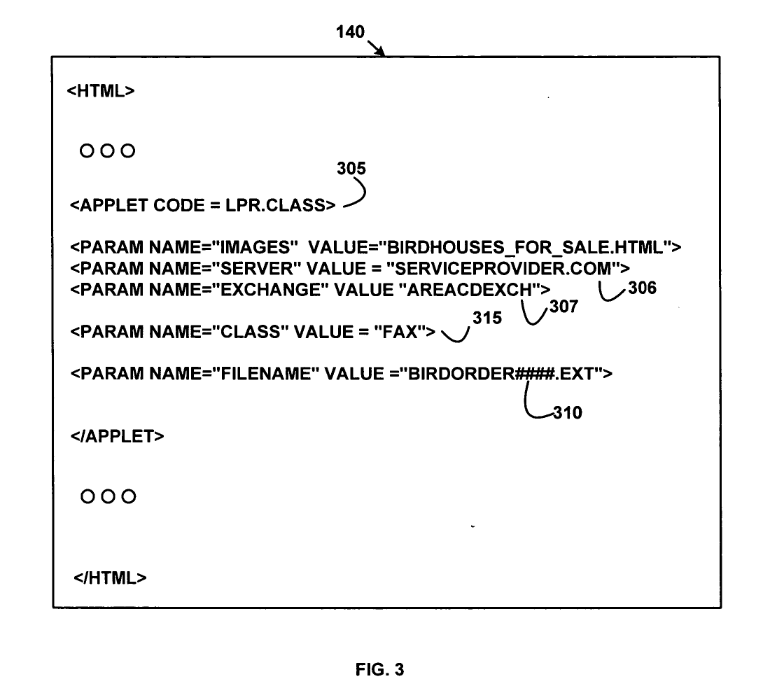

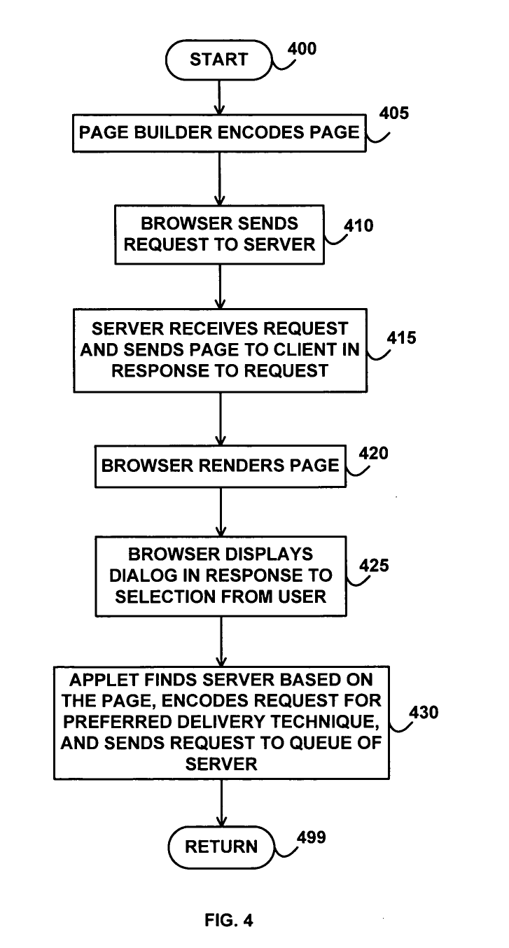

The website server 102 receives a request from the client 104 and in response sends the page 140 and the associated applet to the client 104 via the network 108. The functions of the page builder 141 are further described below with reference to FIG. 4. In an embodiment, the page builder 141 includes instructions capable of executing on a processor (unillustrated) or statements capable of being interpreted by instructions executing on a processor. In another embodiment, the page builder 141 may be implemented in hardware via logic gates and/or other appropriate hardware techniques in lieu of or in addition to a processor-based system. The page 140 includes control tags and data and identifies contact information for the recipient 130. An example of a portion of the page 140 is further described below with reference to FIG. 3.

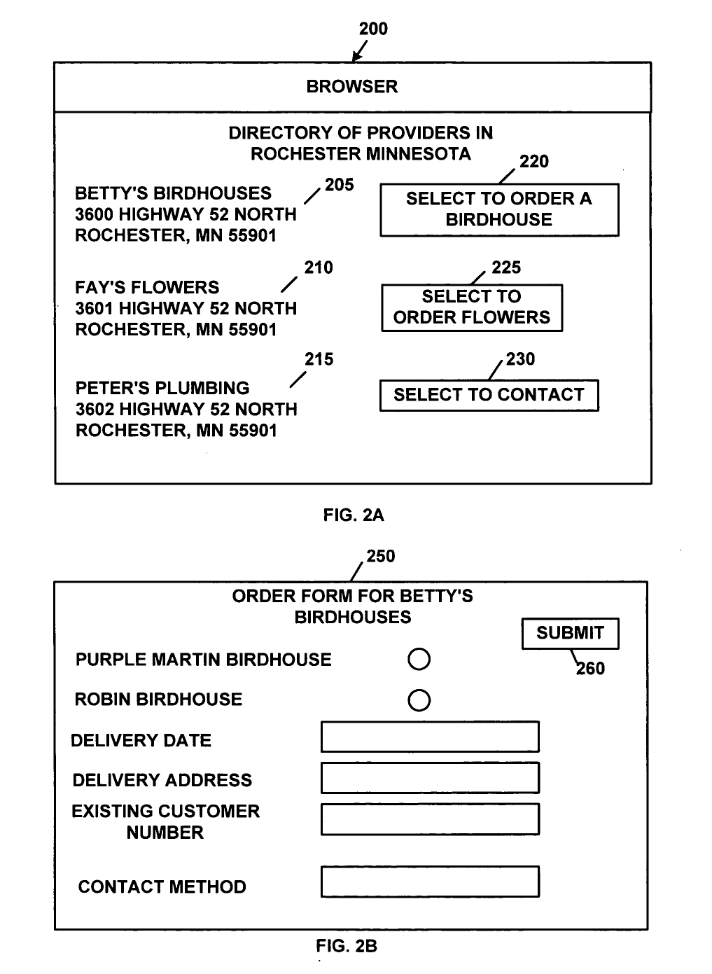

The client 104 includes a browser 150, an input device 151 and an output device 152. The browser 150 finds and retrieves the page 140 from the website server 102 via the network 108. The browser 150 may find the page 140 via a search engine located at any appropriate server on the network 108, via a favorites list, bookmarks, or via any other appropriate means. The browser 150 further interprets the control tags in the page 140 to render the page 140 for display on the output device 152, as further described below with reference to FIG. 2A. When the user selects the recipient 130 in the page 140 and submits a message via the input device 151, as further described below with reference to FIG. 2B, the applet associated with the page 140 sends the message to the server 106. The applet may further prompt the user of the client 104 for an order selection, order information, or any other appropriate information. The functions of the browser 150 are further described below with reference to FIG. 4.

The input device 151 may be a keyboard, mouse or other pointing device, trackball, touchpad, touchscreen, keypad, microphone, voice recognition device, or any other appropriate mechanism for the user to input data to the client 104 and/or to manipulate the user interfaces of the client 104. Although only one input device 151 is shown, in another embodiment any number and type of input devices may be present.

The output device 152 is that part of the client 104 that presents output to the user. The output device 152 may be a cathode-ray tube (CRT) based video display well known in the art of computer hardware. But, in other embodiments the output device 152 may be replaced with a liquid crystal display (LCD) based or gas, plasma-based, flat-panel display. In still other embodiments, any appropriate display device may be used. In other embodiments, a speaker or a printer may be used. In other embodiments any appropriate output device may be used. Although only one output device 152 is shown, in other embodiments, any number of output devices of different types or of the same type may be present. The output device 152 may display or otherwise present the user interfaces, such as the user interfaces and output further described below with reference to FIGS. 2A and 2B.

The server 106 includes a processor 160, a storage device 162, an input device 164, and an output device 168, all connected directly or indirectly via a bus 170. The processor 160 represents a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. The processor 160 executes instructions and includes that portion of the server 106 that controls the operation of the entire server. Although not depicted in FIG. 1, the processor 160 typically includes a control unit that organizes data and program storage in memory and transfers data and other information between the various parts of the server 106. The processor 160 reads and/or writes code and data to/from the storage device 162, the network 108, the input device 164, and/or the output device 168. Although the server 106 is drawn to contain only a single processor 160 and a single bus 170, embodiments of the present invention apply equally to electronic devices that may have multiple processors and multiple buses with some or all performing different functions in different ways.

The storage device 162 represents one or more mechanisms for storing data. For example, the storage device 162 may include read only memory (ROM), random access memory (RAM), magnetic disk storage media, optical storage media, flash memory devices, and/or other machine-readable media. In other embodiments, any appropriate type of storage device may be used. Although only one storage device 162 is shown, multiple storage devices and multiple types of storage devices may be present. Although the storage device 162 is shown in FIG. 1 as a single monolithic entity, the storage device 162 may in fact be distributed and/or hierarchical, as is known in the art. For example, the storage device 162 may exist in multiple levels of storage devices, and these levels of storage devices may be further divided by function, so that one level of storage device holds, e.g., instructions while another holds, e.g., non-instruction data which is used by the processor or processors. The storage device 162 may further be distributed and associated with different processors or sets of processors, as is known in any of various so-called non-uniform memory access (NUMA) computer architectures. Further, although the server 106 is drawn to contain the storage device 162, it may be distributed across other electronic devices, such as electronic devices connected to the network 108.

The storage device 162 includes a controller 172 and queues 174, all of which may in various embodiments exist in any number. Although the controller 172 and the queues 174 are both illustrated as being contained within the storage device 162 in the server 106, in other embodiments some or all of them may be on different electronic devices and may be accessed remotely, e.g., via the network 108.

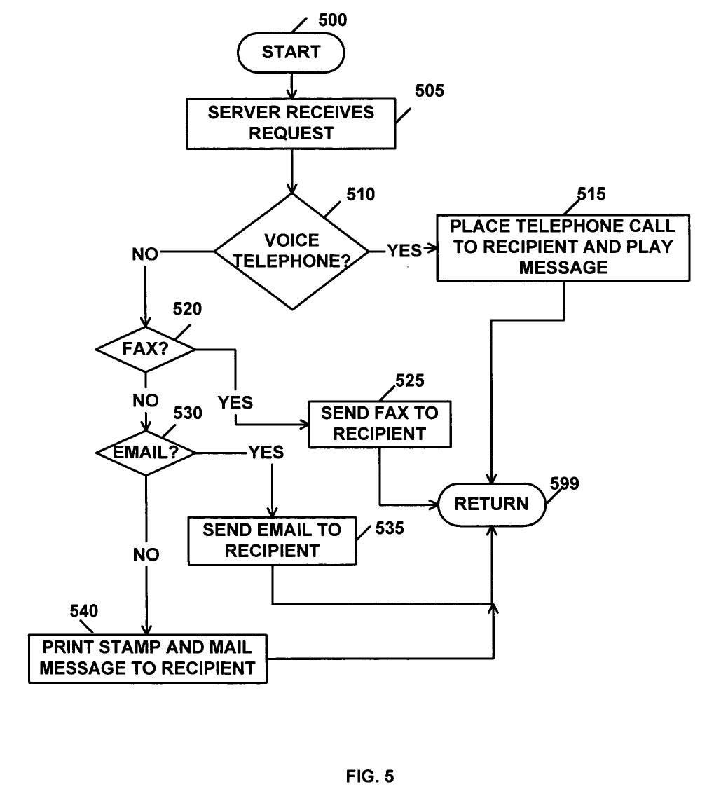

The controller 172 processes messages on the queues 174 and sends the messages from the server 106 to the recipient 130 based on the preferred technique via the telnet server 176 and the network 108 or the computer 124. In an embodiment, the controller 172 includes instructions capable of executing on the processor 160 or statements capable of being interpreted by instructions executing on the processor 160 to perform the functions as further described below with reference to FIG. 5. In another embodiment, the controller 172 may be implemented in hardware via logic gates and/or other appropriate hardware techniques in lieu of or in addition to a processor-based system. In an embodiment, the queues 174 may be associated with each of the respective printers 126. In an embodiment, the queues 174 are printer queues that are repositories for spool files. Spool files can be enqueued remotely onto the queues 174 using a Line Printer Requester (LPR) at the client 104. LPR communicates/transfers spool files to the queues 174 by communicating with a Line Printer Daemon (LPD) application at the server 106. In various embodiments, LPR may be native at the client 104, an applet at the client 104 may invoke LPR, or a servlet may invoke LPR from the website server 102.

The server 106 also includes the telnet server 176. In an embodiment the telnet server 176 runs TCP/IP (Transmission/Internet Protocol) Telnet according to RFC (Request for Comments) 2877, which is an application that provides a terminal to the server 106, which is used to gain access to machines (such as the computer 124 and/or the printer 126) and run other applications as the server 106 desires. RFC 2877 describes the interface to the Telnet server 176 that allows the computer 124 to request a Telnet terminal or printer session. The Telnet server 176 allows the controller 172 at the server 106 to print the spool file at the printer 126 or send the spool file to the recipient 130 via the network 108 or the telephone network 128 via the computer 124

The bus 170 may represent one or more busses, e.g., PCI (Peripheral Component Interconnect), ISA (Industry Standard Architecture), X-Bus, EISA (Extended Industry Standard Architecture), or any other appropriate bus and/or bridge (also called a bus controller). Although the bus 170 is shown in FIG. 1 as a relatively simple, single bus structure providing a direct communication path among the processor 160, the storage device 162, the input device 164, and the output device 168, in other embodiments the bus 170 may comprise multiple different buses or communication paths, which may be arranged in any of various forms, such as point-to-point links in hierarchical, star or web configurations, multiple hierarchical buses, or parallel and redundant paths. Furthermore, while the bus 170 is shown directly connected to the processor 160, the storage device 162, the input device 164, and the output device 168, in other embodiments, some or all of the I/O (Input/Output) devices may be connected via I/O processors.

The network 108 may be any suitable network or combination of networks and may support any appropriate protocol suitable for communication of data and/or code to/from the website server 102, the client 104, the server 106, the telnet server 176, the computer 124, and/or the printer 126. In various embodiments, the network 108 may represent a storage device or a combination of storage devices, either connected directly or indirectly to the website server 102, the client 104, and/or the server 106. In an embodiment, the network 108 may support Infiniband. In another embodiment, the network 108 may support wireless communications. In another embodiment, the network 108 may support hard-wired communications, such as a telephone line or cable. In another embodiment, the network 108 may support the Ethernet IEEE (Institute of Electrical and Electronics Engineers) 802.3x specification. In another embodiment, the network 108 may be the Internet and may support IP (Internet Protocol). In another embodiment, the network 108 may be a local area network (LAN) or a wide area network (WAN). In another embodiment, the network 108 may be a hotspot service provider network. In another embodiment, the network 108 may be an intranet. In another embodiment, the network 108 may be a GPRS (General Packet Radio Service) network. In another embodiment, the network 108 may be a FRS (Family Radio Service) network. In another embodiment, the network 108 may be any appropriate cellular data network or cell-based radio network technology. In another embodiment, the network 108 may be an IEEE 802.11B wireless network. In still another embodiment, the network 108 may be any suitable network or combination of networks. Although one network 108 is shown, in other embodiments any number of networks (of the same or different types) may be present.

The recipient 130 is the recipient of the message from the client 104. In various embodiments, the recipient 130 may be a fax machine, pager, telephone, or email inbox. In other embodiments, the recipient 130 may be a physical office, building, house, or mailbox. In various embodiments, the recipient 130 may be associated with or owned by a business, individual, group, government entity, or any other organization.

The website server 102, the client 104, the server 106, and the computer 124 may be implemented using any suitable hardware and/or software, such as a personal computer. The computer 124 may implement a telnet client and in various embodiments may be any network-connected host computer or an integrated IBM X Series (IXS). Portable computers, laptop or notebook computers, PDAs (Personal Digital Assistants), pocket computers, telephones, pagers, automobiles, teleconferencing systems, appliances, and mainframe computers are examples of other possible configurations. The hardware and software depicted in FIG. 1 may vary for specific applications and may include more or fewer elements than those depicted. For example, other peripheral devices such as audio adapters, or chip programming devices, such as EPROM (Erasable Programmable Read-Only Memory) programming devices may be used in addition to or in place of the hardware already depicted.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the website server 102, the client 104, the server 106, and the computer 124 and that, when read and executed by one or more processors cause the website server 102, the client 104, the server 106, and/or the computer 124 to perform the steps necessary to execute steps or elements embodying the various aspects of an embodiment of the invention.

Moreover, while embodiments of the invention have and hereinafter will be described in the context of fully functioning electronic devices, the various embodiments of the invention are capable of being distributed as a program product in a variety of forms, and the invention applies equally regardless of the particular type of signal-bearing medium used to actually carry out the distribution. The programs defining the functions of this embodiment may be delivered to the website server 102, the client 104, the server 106, and/or the computer 124 via a variety of signal-bearing media, which include, but are not limited to:
(1) information permanently stored on a non-rewriteable storage medium, e.g., a read-only memory device attached to or within an electronic device, such as a CD-ROM readable by a CD-ROM drive;
(2) alterable information stored on a rewriteable storage medium, e.g., a hard disk drive or diskette; or
(3) information conveyed to an electronic device by a communications medium, such as through a computer or a telephone network, e.g., the network 108, including wireless communications.

Such signal-bearing media, when carrying machine-readable instructions that direct the functions of the present invention, represent embodiments of the present invention.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2A depicts a pictorial representation of an example user interface 200 displayed on the output device 152 (FIG. 1), according to an embodiment of the invention. The browser 150 interprets the control tags and data in the page 140 in order to display the page 140 as the user interface 200 on the output device 152. In various embodiments, the page 140 may range from a simple directory listing for the recipient 130 to a complex web presence. In another embodiment, the page 140 is the home page of a business, organization, or individual. In another embodiment, the page 140 may be any page that identifies at least one potential recipient 130.

The example user interface 200 includes identifications 205, 210, and 215 of the recipients 130. The example user interface 200 also includes buttons 220, 225, and 230, which when selected via the input device 151 cause the browser 150 to interpret the control tags and data in the page 140 to give the user an opportunity to enter a message or an order to send to the associated recipient 130. For example, if the user selects the button 220, the browser 150 displays example dialog shown in FIG. 2B.

FIG. 2B depicts a pictorial representation of an example dialog 250 for entering a message intended for delivery to the associated recipient 130, according to an embodiment of the invention. In various embodiments, the message may include text, graphics, audio, video, or any other data. Also, the message may serve any purpose. For example, the message may include an order for goods or services, may include a request for information, may serve to deliver information, or may serve any other appropriate purpose. The dialog 250 includes a submit button 260, which when selected via the input device 151 causes the message or other information entered via the dialog 250 to be delivered to the recipient 130 as further described below with reference to FIGS. 3, 4, and 5.

FIG. 3 depicts a block diagram of a portion of example source for the page 140, according to an embodiment of the invention. In an embodiment, the page 140 is an Internet web page and is encoded via the HTML (Hypertext Markup Language), but in other embodiments XML or any other appropriate protocol may be used. The page 140 includes various control tags and data (not shown), which the browser renders for display as the user interfaces 200 and 250 previously shown in FIGS. 2A and 2B, respectively. The page 140 also includes an identification of an applet 305, an identification 306 of the server 106, an area code and exchange 307 of the recipient 130, a telephone number 310 of the recipient 130, and a preferred technique 315 for communicating with the recipient 130. The telephone number 310 includes distinguishing digits beyond the area code and exchange 307 or country code.

The page builder 141 encoded the applet 305, the identification 306 of the server, the area code and exchange 307, the telephone number 310, and the preferred technique 315 into the page 140. In an embodiment, the areacode and exchange 307 are associated with the server 106. In another embodiment, only the areacode may be associated with the server 106. By associating the areacode or areacode and exchange with the server 106 and locating the server 106 within the areacode, long distance telephone charges can be avoided. In other embodiments, the page 140 may also include a country code. The queues 174 can be associated with the country code, the area code, and/or the exchange.

The applet 305 may be encoded in JavaScript or any other appropriate language. The applet 305 may be interpreted by the browser 150 or an interpreter or executed on an unillustrated processor of the client 104. The browser 150 passes the identification 306 of the server 106, the areacode and exchange 307, the telephone number 310 and the preferred technique 315 as parameters to the applet 305 when the browser 150 invokes the applet 305 in response to the user selecting a button in the user interface 250, (the submit button 260 in this example). In an embodiment, the applet 305 enqueues the message/spool file using LPR where the areacode is the “-S” LPR keyword, the exchange is the “-P” LPR keyword, and the distinguishing digits of the telephone number 310 are appended to the file name. For example, a LPR command for the example data shown in FIG. 3 may be: LPR-S serviceprovider.com-P areacdexch-C FAX birdorder####.ext.

The control tags and data in FIG. 3 are examples only and any appropriate tags and data may be present. For example, a voice telephone, email address, and/or physical mailing address may be present as parameters in addition to or instead of the parameters 307 and 310 for the applet 305 shown. Further, the preferred technique 315 may designate delivery to the recipient via voice telephone, email, physical mail, delivery service, or any other appropriate technique in addition to the fax technique shown.

FIG. 4 depicts a flowchart of example processing, according to an embodiment of the invention. Control begins at block 400. Control then continues to block 405 where the page builder 141 encodes information into the page 140. In various embodiments, the page builder 141 may encode information about the recipient 130, the recipient's products and/or services, an order form or forms, contact information, a telephone and/or fax number, an email address, a street address, the preferred contact technique for the recipient 130, or any combination thereof.

Control then continues to block 410 where the browser 150 sends a request for the page 140 to the website server 102. Control then continues to block 415 where the website server 102 receives the request from the client 104 and sends the page 140 to the client 104 in response to the request. Control then continues to block 420 where the browser 150 interprets the control tags and data in the page 140 and renders the page 140 for display on the output device 152, as previously described above with reference to FIG. 2A. The rendered page includes an identification of at least one recipient 130. Control then continues to block 425 where the browser 150 receives a selection of an intended recipient via the input device 151, displays the dialog 250 in response, and receives data from the user, such as a message or order form, which is intended for the recipient 130, as previously described above with reference to FIG. 2B.

Control then continues to block 430 where the browser 150 invokes, calls, or interprets the applet 305 identified in the page 140. The applet 305 determines the server 106 from the identification 306 in the page 140. In various embodiments, the encoded server 106 that is associated with the telephone number 310 serves to reduce or eliminate any long distance telephone charges that might be associated with sending the message to the recipient 130 or to reduce the delivery time, expenses, and security exposure that might be associated with mailing or delivering the message to the recipient 130. For example, the server 106 may be physically located within the region served by the area code or the area and exchange 307.

The applet 305 also finds the preferred delivery technique 315 for the recipient 130 in the page 140. The applet 305 encodes the preferred delivery technique and sends the message to the designated server 106. In an embodiment, the applet 305 encodes the message into a file whose name includes the telephone number 310 and the preferred delivery technique in a LPR (Line Printer Remote) command, which then sends the LPR command file to the queue 174 (identified by the area code and exchange 307) on the server 106. Control then continues to block 499 where the logic of FIG. 4 returns.

FIG. 5 depicts a flowchart of example processing, according to an embodiment of the invention. Control begins at block 500. Control then continues to block 505 where the controller 172 at the server 106 receives the message that was sent from the client 104 at block 430 (FIG. 4). In an embodiment, the controller 172 dequeues the message from one the queues 174 that is associated with a printer 126, an area code, an exchange, or a network. In an embodiment, the controller 172 operates using the LPD (Line Printer Daemon) protocol, but in other embodiments any appropriate protocol may be used.

Control then continues to block 510 where the controller 172 determines whether the preferred delivery technique for the received message is a voice telephone call. If the determination at block 510 is true, then control continues to block 515 where the controller 172 sends a request (including a destination telephone number aggregated from the encoded parameters 306, 307, and 310, as previously described above) to the telnet server 176, which instructs the computer 124 to place a telephone call via the telephone network 128 to the recipient 130 and play the message. In various embodiments, the controller 172, the telnet server 176, or the computer 124 performs a text-to-speech function on the message in order to provide an audio message to play to the recipient 130. For example, the server 106 may have a native voice response unit (VRU), or the computer 124 may have remote technology. Control then continues to block 599 where the logic of FIG. 5 returns.

If the determination at block 510 is false, then control continues to block 520 where the controller 172 determines whether the preferred delivery technique for the received message is a fax transmission. If the determination at block 520 is true, then control continues to block 525 where the controller 172 sends a request (including a destination telephone number aggregated from the encoded parameters 306, 307, and 310, as previously described above) to the telnet server 176, which instructs the telnet server 176 to send a fax of the message to the recipient via the computer 124 and the telephone network 128. Control then continues to block 599 where the logic of FIG. 5 returns.

If the determination at block 520 is false, then control continues to block 540 where the controller 172 determines whether the preferred delivery technique for the received message is an email. If the determination at block 530 is true, then control continues to block 535 where the controller 172 sends a request to the telnet server 176, which instructs the telnet server 176 to send an email that includes the message to the recipient 130 via the network 108. Control then continues to block 599 where the logic of FIG. 5 returns.

If the determination at block 530 is false, then control continues to block 540 where the controller 172 sends a request to the telnet server 176, which instructs the computer 124 to print and mail the message to the recipient 130 via the postal service or other delivery service. In various embodiments, the controller 172, the telnet server 176, or the computer 124 performs a speech-to-text function in order to provide a text message capable of being printed. Control then continues to block 599 where logic of FIG. 5 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

1. A method comprising:
determining a server and a preferred delivery technique associated with a recipient in response to a message intended for the recipient selected via a page; and
sending the message and an indication of the preferred delivery technique to the server.

2. The method of claim 1, wherein the sending further comprises:
finding an area code of the recipient in the page; and
sending the message and the indication to a queue at the server, wherein the queue is based on at least the area code.

3. The method of claim 1, wherein the preferred delivery technique is encoded in the page.

4. The method of claim 1, wherein the preferred delivery technique comprises a fax transmission and the telephone number is a fax number.

5. The method of claim 1, wherein the preferred delivery technique comprises a physical delivery.

6. An apparatus comprising:
means for determining a server and a preferred delivery technique associated with a recipient in response to a message intended for the recipient selected via a page, wherein the preferred delivery technique is encoded in the page; and
means for sending the message to the recipient via the preferred delivery technique and the server.

7. The apparatus of claim 6, wherein the means for sending further comprises:
means for finding an area code of the recipient in the page; and
means for sending the message to a queue at the server, wherein the queue is based on at least the area code.

8. The apparatus of claim 6, wherein the preferred delivery technique comprises a fax transmission and the telephone number is a fax number.

9. The apparatus of claim 6, wherein the preferred delivery technique comprises a physical delivery.

10. The apparatus of claim 6, wherein the message further comprises an order for goods or services.

11. A signal-bearing medium encoded with instructions, wherein the instructions when executed comprise:
encoding an identification of a recipient, a telephone number for the recipient, and a preferred delivery technique for messages intended for the recipient into a page.

12. The signal-bearing medium of claim 11, wherein the telephone number is associated with a server for delivering the messages.

13. The signal-bearing medium of claim 11, wherein the telephone number is a fax number of the recipient.

14. The signal-bearing medium of claim 11, wherein the preferred delivery technique comprises a fax transmission.

15. The signal-bearing medium of claim 12, wherein the server is located within an area code of the telephone number.

16. An electronic device comprising:
a processor; and
a storage device encoded with instructions, wherein the instructions when executed on the processor comprise:
determining a server and a preferred delivery technique associated with a recipient in response to a message intended for the recipient selected via a page, wherein the preferred delivery technique and an identification of the server are encoded in the page, and
sending the message to the recipient via the preferred delivery technique and the server.

17. The electronic device of claim 16, wherein the server is located within an area code of a telephone number encoded in the page.

18. The electronic device of claim 17, wherein the telephone number is a fax number of the recipient.

19. The electronic device of claim 16, wherein the preferred delivery technique comprises a fax transmission.

20. The electronic device of claim 16, wherein the preferred delivery technique comprises a physical delivery.

21. A method of configuring a computing device to perform a method of contacting a recipient by a preferred technique via a page, the method comprising:
configuring a computing device to determine a server and a preferred delivery technique associated with a recipient in response to a message intended for the recipient selected via a page; and configuring the computing device to send the message and an indication of the preferred delivery technique to the server.
